(19) United States
(12) Patent Application Publication
(10) Pub. No.: US 2006/0101474 A1
(43) Pub. Date: May 11, 2006

(54) System, method and apparatus for an extensible distributed enterprise integration platform

(76) Inventor: Bruce Magown, Stamford, CT (US)

Correspondence Address: CHALKER FLORES, LLP, 2711 LBJ FRWY, Suite 1036, DALLAS, TX, 75234, US

(21) Appl. No.: 11/269,459

(22) Filed: Nov. 8, 2005

Related U.S. Application Data
(60) Provisional application No. 60/626,164, filed on Nov. 8, 2004.

(51) Int. Cl. G06F 9/44

(52) U.S. Cl. 719/315

(57) ABSTRACT

The present invention provides a system, method and apparatus for an extensible distributed enterprise integration platform that includes a server communicably coupled to a connector and an adapter. The server loads a transaction from a translated service request, executes each transaction step of the transaction by identifying an adapter to communicate with a resource, determining a result for the executed transaction step, creating a service response for the service request and passing the service response to the connector. The connector receives the service request from a requestor, translates the service request, passes the translated service request to the server, translates the service response and sends the translated service response to the requester. The adapter establishes a session with the resource, translates the transaction step, sends the request to the resource, receives a response from the resource, translates the response and passes the translated response to the server.

### REFERENCE TO RELATED APPLICATIONS

This application claims priority to U.S. Provisional Patent Application No. 60/626,164 filed Nov. 8, 2004 entitled Extensible Distributed Enterprise Integration Platform, which is herein incorporated by reference in its entirety.

### FIELD OF THE INVENTION

The present invention relates generally to the field of transaction processing systems (e.g., “Information Integration Management”, “Enterprise Application Integration” and “Enterprise Information Integration”) and, more particularly, to a connector-server-adapter architecture used to act upon and integrate applications and data normally deployed in networked computing environments.

### BACKGROUND OF THE INVENTION

Over the last several decades, organizations have spent hundreds of billion of dollars creating and maintain applications and databases (heretofore referred to as “systems”) that support their business. Because these systems where developed at different points in time, by different project teams, using different technology, these systems typically are not fully compatible and have limited ability to interoperate,

As a result, companies that need to integrate their systems have had to build software programs that link applications, and in many cases replicate their data so it may be used by non-compatible systems. The problem with these solutions is that they are time-consuming and costly to develop and support due to their technical complexity and limited commonality and re-usability of solutions for one instance of the problem to the next.

Over the last few years, the software industry has begun to help companies address these issues through the creation of standards, messaging middleware, integration oriented Interactive Development Environments (IDEs), and data distribution and mapping products.

Accordingly there is a need for a solution that takes a new tack on the problem. While most solutions to-date have focused on facilitating building software integration programs, a new solution is needed that focuses on embedding the systems integration process in to a platform which companies can use to integrate systems automatically.

### SUMMARY OF THE INVENTION

The present invention provides a system, method and apparatus for an extensible distributed enterprise integration platform that solves the problems associated with current software integration programs and focuses on embedding the systems integration process in to a platform which companies can use to integrate systems automatically. In general, in one aspect, the present invention provides an extensible software platform that integrates systems, databases, and services across technology and organizational boundaries. This platform consists of a set of server components and application program interfaces. In one aspect, the platform serves as a proxy between two or more systems (e.g. applications, databases, services, devices). In another aspect, the platform serves as a service which manages and coordinates complex transactions across systems boundaries.

There are two types of server components—business daemons (schedulers) and integration servers. The integration server comprises three major components—transformation server, adaptor(s) and connector(s). The business daemon is a component that allows starting integration transactions according to pre-defined schedule. The transformation server is an integration engine, which executes integration transactions. The adaptors implement application program interfaces that provide bi-directional communication between the server to different applications, databases, services and devices outside the server. Connectors bind applications or services (internal such as business daemon and external), which initiate integration transactions, to the transformation server.

The server components are programmed using Java, XML, XLST and XPath. XML stands for Extensible Markup Language which is a standard format for documents containing structured information. XSLT stands for XML Transformations which is a language for transforming XML and other (such as HTML, text, etc.) types of documents. XPath stands for XML Path Language which is an expression language used by XSLT to access or refer to parts of an XML document.

The platform can extend to accommodate new systems by writing new connectors and adapters that implement application program interfaces (APIs), which translate systems protocols to a common format understood by the platform. This decoupling of the transformation server from the external system protocol has the effect of simplifying the server and allowing it to appear as different types of servers depending on which API is used to connect to it. For example, when using the HTML API the server appears to be a Web Server, when using the SOAP API the server appears to be a SOAP Server, when using the WAP API the server appears to be a WAP Server, when using the AMF API the server appears to be a Flash Remoting Server, etc.

The dynamic generation of system queries and commands based on the incoming data translated into internal format allows building flexible and generic integration transactions applicable to the variety of data sources and destinations without necessity to develop a new code. Furthermore, the combination of systems integration via a server, involving no definition or generation of program code, the decoupling of protocols, the dynamic command generation, the ability to easily accommodate new data systems and technologies, and the ability to masquerade as other servers, is to our knowledge is unique in the industry. As a result, the present invention provides for significant time and cost advantages over other approaches of systems integration.

More specifically, the present invention provides a method for processing a service request in real time using an enterprise integration platform that includes a server communicably coupled to one or more connectors and one or more adapters. The service request is received at the connector from a requestor communicably coupled to the connector. The service request contains a transaction comprising one or more transaction steps. The service request is translated into a server compatible format and the translated service request is passed to the server. The transaction is then loaded from the translated service request and each step of the transaction is executed. Whenever the execution of the transaction step requires accessing a resource, one of the adapters is identified to communicate with the resource, a bi-directional communication session is established between the identified adapter and the resource, the transaction step is translated into a request compatible with the resource, the request is sent to the resource, a response is received from the resource, the response is translated into the server compatible format and the translated response is passed to the server. A result for the executed transaction step is then determined. A service response for the service request is then created based on the results for the executed transaction steps, the service response is passed to the connector where the service response is translated into a requester compatible format and the translated service response is sent to the requestor. Note that this method can be implemented using a computer program embodied on a computer readable medium where each step is executed by one or more code segments.

In addition, the present invention provides an enterprise integration platform for processing a service request containing a transaction that includes one or more transaction steps in real time. The enterprise integration platform includes a server communicably coupled to one or more connectors and one or more adapters. The server loads the transaction from a translated service request, executes each transaction step of the transaction by identifying an adapter to communicate with a resource when necessary, determining a result for the executed transaction step, creating a service response for the service request based on the results for the executed transaction steps and passing the service response to a connector. The connector receives the service request from a requestor, translates the service request into a server compatible format, passes the translated service request to the server, translates the service response into a requestor compatible format and sends the translated service response to the requestor. The adapter establishes a bi-directional communication session with the resource, translates the transaction step into a request compatible with the resource, sends the request to the resource, receives a response from the resource, translates the response into the server compatible format and passes the translated response to the server.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 provides a business view on the types of applications, systems and services that may be integrated in accordance with one embodiment of the present invention;

FIG. 2 depicts the Enterprise Integration Platform (EIP) in accordance with one embodiment of the present invention;

FIG. 3 illustrates example of the plurality requestors and data-system objects that are accessed, updated and integrated and examples of supported protocols in accordance with one embodiment of the present invention;

FIG. 4 illustrates the Application Service and Management Service of the Enterprise Integration Server in accordance with one embodiment of the present invention;

FIGS. 5A and 5B illustrate a method for processing a transaction in accordance with the present invention;

FIG. 6 illustrates the steps involved in a request cycle and how the process is supported in accordance with one embodiment of the present invention; and

FIGS. 7A, 7B, 7C and 7D illustrate some of the many ways the server can be laid out in a physical network in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to enterprise integration systems, but it will be understood that the concepts of the present invention are applicable to any transaction processing system in which automatic integration is desireable.

The present invention provides a system, method and apparatus for an extensible distributed enterprise integration platform that solves the problems associated with current software integration programs and focuses on embedding the systems integration process in to a platform which companies can use to integrate systems automatically. In general, in one aspect, the present invention provides an extensible software platform that integrates systems, databases, and services across technology and organizational boundaries. This platform consists of a set of server components and application program interfaces. In one aspect, the platform serves as a proxy between two or more systems (e.g. applications, databases, services, devices). In another aspect, the platform serves as a service which manages and coordinates complex transactions across systems boundaries.

There are two types of server components—business daemons (schedulers) and integration servers. The integration server comprises three major components—transformation server, adaptor(s) and connector(s). The business daemon is a component that allows starting integration transactions according to pre-defined schedule. The transformation server is an integration engine, which executes integration transactions. The adaptors implement application program interfaces that provide bi-directional communication between the server to different applications, databases, services and devices outside the server. Connectors bind applications or services (internal such as business daemon and external), which initiate integration transactions, to the transformation server.

The server components are programmed using Java, XML, XLST and XPath. XML stands for Extensible Markup Language which is a standard format for documents containing structured information. XSLT stands for XML Transformations which is a language for transforming XML and other (such as HTML, text, etc.) types of documents. XPath stands for XML Path Language which is an expression language used by XSLT to access or refer to parts of an XML document.

The platform can extend to accommodate new systems by writing new connectors and adapters that implement application program interfaces (APIs), which translate systems protocols to a common format understood by the platform. This decoupling of the transformation server from the external system protocol has the effect of simplifying the server and allowing it to appear as different types of servers depending on which API is used to connect to it. For example, when using the HTML API the server appears to be a Web Server, when using the SOAP API the server appears to be a SOAP Server, when using the WAP API the server appears to be a WAP Server, when using the AMF API the server appears to be a Flash Remoting Server, etc.

The dynamic generation of system queries and commands based on the incoming data translated into internal format allows building flexible and generic integration transactions applicable to the variety of data sources and destinations without necessity to develop a new code. Furthermore, the combination of systems integration via a server, involving no definition or generation of program code, the decoupling of protocols, the dynamic command generation, the ability to easily accommodate new data systems and technologies, and the ability to masquerade as other servers, is to our knowledge is unique in the industry. As a result, the present invention provides for significant time and cost advantages over other approaches of systems integration.

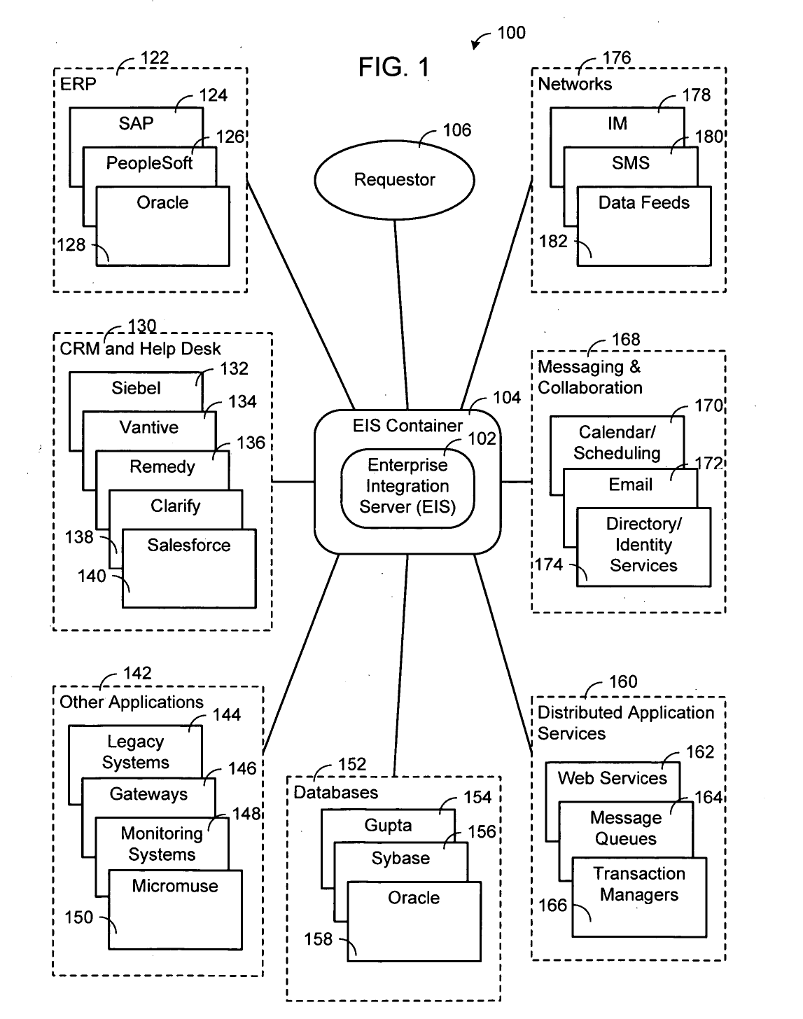

Now referring to FIG. 1, a business view on the types of applications, systems and services that may be integrated in accordance with one embodiment of the present invention is shown. The Enterprise Integration Platform (EIP) 100 in one aspect consists of extensible run-time Enterprise Integration Server (EIS) 102 that provides a mechanism to link systems, transform and exchange data, and executes workflow processes across technology environments. The EIS 102 runs within a Run-Time Container 104 such as an application server, web application server, or servlet engine.

Requestors 106 (which may include business daemon as well as external applications or services) call the server 102 and ask it to run a particular transaction. The transaction is loaded into the server 102 and executes. The transaction may be simple or complex and may involve few or many steps and data-system objects (122-57 and collectively referred to as resources 120). The transactions are defined in XML/XSLT and compiled and deployed to the Run-Time Container 104 for enhanced performance and security.

Examples of data-systems objects or resources 120 which are integrated by the server 102 include Enterprise Resource Planning (ERP) applications 122 (e.g., SAP 124, PeopleSoft 126, Oracle 128, etc.), Customer Relationship Management (CRM) and help desk applications 130 (e.g., Siebel 132, Vantive 134, Remedy 136, Clarify 138, Salesforce.com 140, etc.), other applications 142 (e.g., legacy systems 144, gateways 146, monitoring systems 148, Micromuse 150, etc.), databases 152 (e.g., Gupta 154, Sybase 156, Oracle 158, etc.), Distributed Application Services 160 (e.g., web services 162, message queues 164, transaction managers 166, etc.), Messaging and Collaboration Technologies 168 (e.g., calendar/scheduling systems 170, email systems 172, directory/identity services 174, etc.), and Networks 176 (e.g., IM 178, SMS (text messaging) 180, data feeds (newswire networks) 182, etc.). Note that any other type of resource can be used with the present invention.

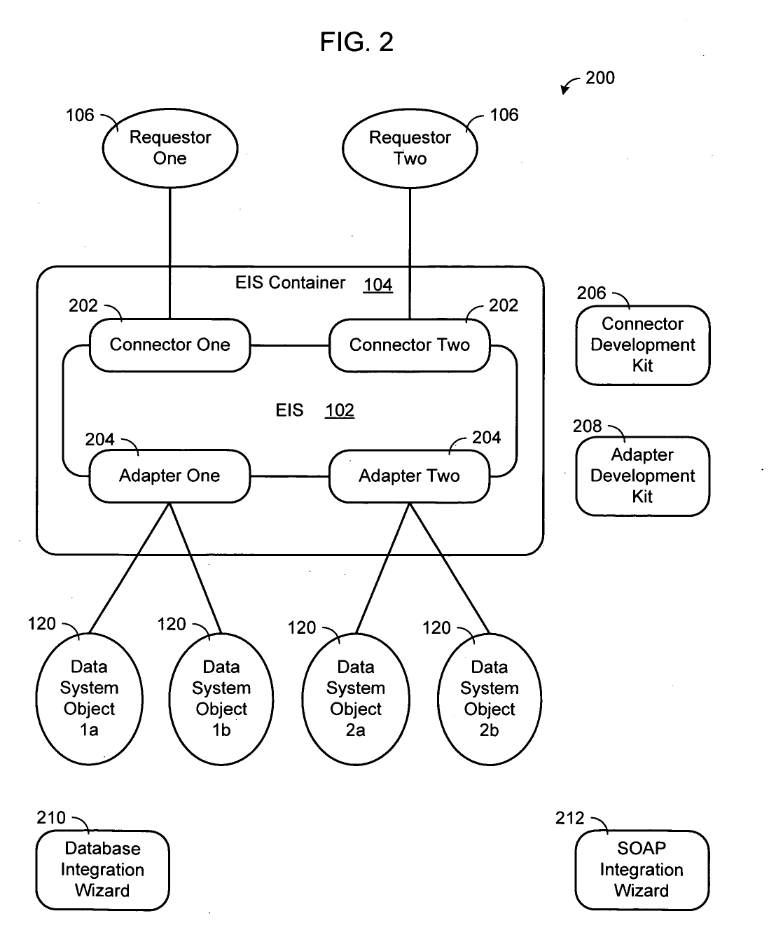

Referring now to FIG. 2, the Enterprise Integration Platform (EIP) 200 in accordance with one embodiment of the present invention is shown. The architecture for the EIP 200 includes an Enterprise Integration Server (EIS) 102 and one or more connectors 202 (e.g., connector one, connector two, etc.) and one or more adapters 204 (e.g., adapter one, adapter two, etc.) that provide real-time and bi-directional communication across a plurality of technology protocols. The purpose of each connector 202 is to provide an ability to start specific transactions or chains of transactions initiated by various requestors 106. The purpose of each adapter 204 is to translate a specific technology protocol used by the data system objects or resources 120 (e.g., data system objects 1a, 1b, 2a and 2b, etc.) to a server compatible format (the EIS Protocol) and then from the EIS Protocol to the specific technology protocol or to specific technology commands, so that disparate technologies, such as ERP systems, CRM systems, legacy applications, databases, etc. (See FIG. 1), can be quickly and easily integrated. The EIS Protocol may include a Java protocol, an Extensible Markup Language (XML) protocol, a XML Transformations (XSLT) protocol or a XML Path Language (XPath) protocol. In this way, the EIS 102 is not restricted in terms of what it can connect to nor is it burdened with the need to understand and support protocols. Protocol translations are performed using protocol specific XSLT Transformers.

The EIS 102 may be accessed by a plurality of requestors 106, through a plurality of connectors 202, and link to a plurality of data-system objects 120, through a plurality of adapters 204. This framework can extended to accommodate new data, systems and technologies by writing new connectors using the connector adapter kit 206, and new adapters using the adapter development kit 208, providing bi-directional translation of open and proprietary protocols to a common format understood by the platform 200. The connector development kit 206 is a source code library of guidelines and templates that is used to model and develop new Connectors. Similarly, the adapter development kit 208 is a source code library of guidelines and templates that is used to model and develop new Adapters. The EIP 200 also includes integration wizards in the form of a database integration wizard 210 and a SOAP integration wizard 212 that automatically map database and SOAP requests to the EIS 102 thereby eliminating the process of typing these maps manually and the possibility of mapping errors being introduced during the typing process. Typically, there will be one integration wizard for each protocol supported by the EIP 200.

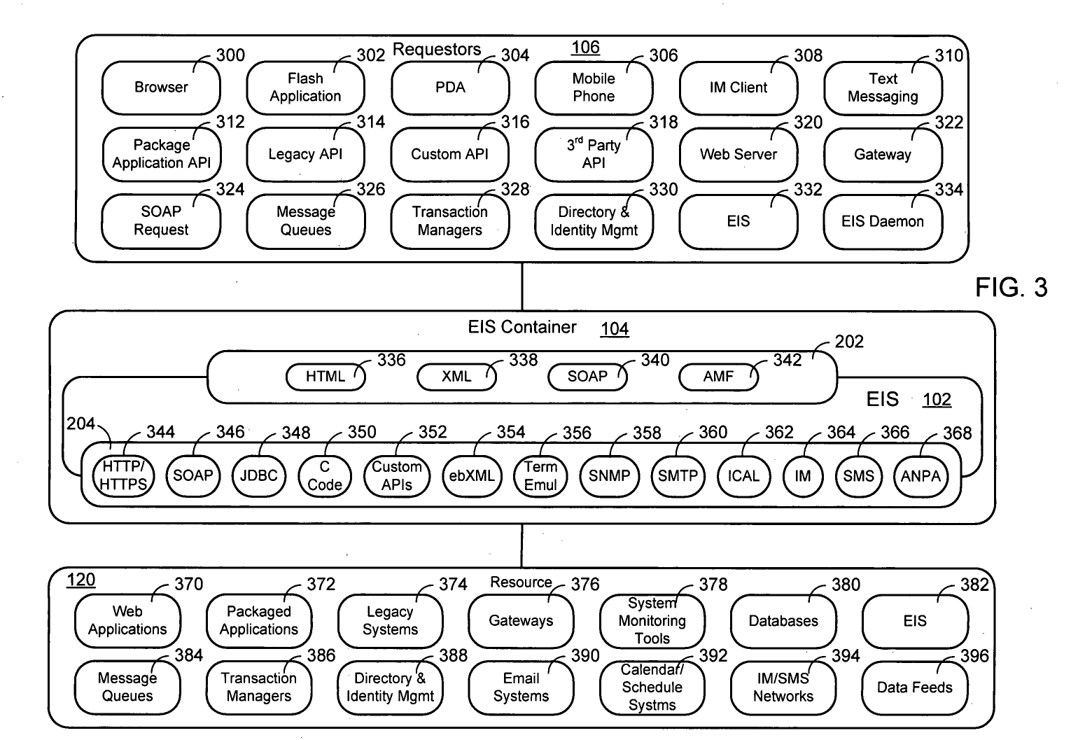

Now referring to FIG. 3, an example of the plurality of requestors 106 and data-system objects (resources 120) that are accessed, updated and integrated and examples of supported protocols in accordance with one embodiment of the present invention is illustrated. As previously stated, the EIS 102 links systems, shares, presents and exchanges data, and creates workflows across technological and organizational boundaries. The process begins with a requestor 106—which may be by virtually any client, system, service, device, application, API, a daemon, etc,—calling the server 102. The server 102 invokes a connector 202 which handles and in-bound and out-bound protocol translation that allow the server 102 and requestor 106 to communicate. The server 102 then initiates the transaction requested by the requestor 106. The transaction instructs the server 102 which data-systems objects (resources 120) it needs to access, and which adapters 204 the server 102 should use to support that communication. The main point of this diagram is it provides some examples of the requestors 106, connectors 202, adapters 204 and data-system objects 120.

For example, the requestor 106 may include a business daemon (scheduler), an internal application, an internal service, an external application, an external service, a browser 300, a flash application 302, a personal data assistant 304, a mobile phone 306, an instant messaging client 308, a text messaging device 310, a package application program interface (API) 312, a legacy API 314, a custom API 316, a third party API 318, a web server 320, a gateway 322, a SOAP request 324, a message queue 326, a transaction manager 328, a directory and identity manager 330, an enterprise integration server 332 or an enterprise integration server daemon 334. The connector 202 may include a HTML container 336, a XML container 338, a SOAP container 340 or an AMF container 342.

The adapter 204 may include a HTTP/HTTPS adapter 344, a SOAP adapter 346, a JDBC adapter 348, a JMS adapter, a C code adapter 350, a custom application program interface adapter 352, an ebXML adapter 354, a terminal emulation adapter 356, a SNMP adapter 358, a SMTP adapter 360, a LDAP adapter, an ICAL adapter 362, an IM adapter 364, a SMS adapter 366 or an ANPA adapter 368. The resource 120 may include a web application 370, a packaged application 372, an ERP system, a CRM system, a help desk, a legacy system 374, a gateway 376, a system monitoring tool 378, a database 380, a distributed application service, a data feed 396, a web service, a message queue 384, a transaction manager 386, a directory/identity management system 388, an e-mail system 390, a calendar/scheduling system 392, an IM/SMS network 394 or an EIS 382.

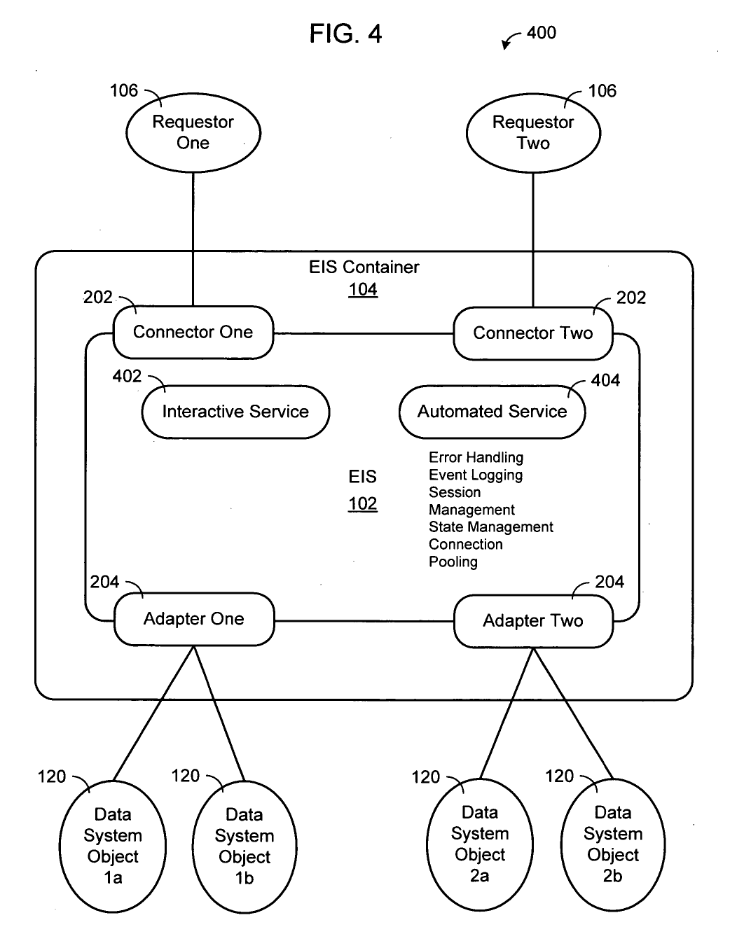

Referring now to FIG. 4, the Application Service and Management Service of the Enterprise Integration Server in accordance with one embodiment of the present invention is illustrated. The EIS 102 includes an interactive service 402 and an automated service 404. The interactive service 402 is an external service and in general provides and manages the transaction processing capabilities of the server 102, whereas the automated service 404 is an internal service and in general provides services that monitor and report the status of the server 102, manage session data, manage database connections, and managed the state of transactions for restart, rollback and transaction integrity purposes. For example, the automated service 404 can provide error handling, event logging, session management, state management and connection pooling.

In other words, the present invention provides an enterprise integration platform 400 for processing a service request containing a transaction that includes one or more transaction steps in real time. The enterprise integration platform 400 includes a server 102 communicably coupled to one or more connectors 202 and one or more adapters 204. The server 102 loads the transaction from a translated service request, executes each transaction step of the transaction by identifying an adapter 204 to communicate with a resource 120 when necessary, determining a result for the executed transaction step, creating a service response for the service request based on the results for the executed transaction steps and passing the service response to a connector 202. The connector 202 receives the service request from a requestor 106, translates the service request into a server compatible format, passes the translated service request to the server 102, translates the service response into a requestor compatible format and sends the translated service response to the requestor 106. The adapter 204 establishes a bi-directional communication session with the resource 120, translates the transaction step into a request compatible with the resource 120, sends the request to the resource 120, receives a response from the resource 120, translates the response into the server compatible format and passes the translated response to the server 102. The requestor 106 is communicably coupled to the connector 202 and the resource 120 is communicably coupled to the adapter 204. As shown in FIGS. 2 and 4, the present invention may include a connector development kit 206 communicably coupled to the server 102, an adapter development kit 208 communicably coupled to the server 102, a SOAP integration wizard 212 communicably coupled to the server 102, a database integration wizard 210 communicably coupled to the server 102, an interactive service 4-2 communicably coupled to the server 102 and/or an automated service 404 communicably coupled to the server 102.

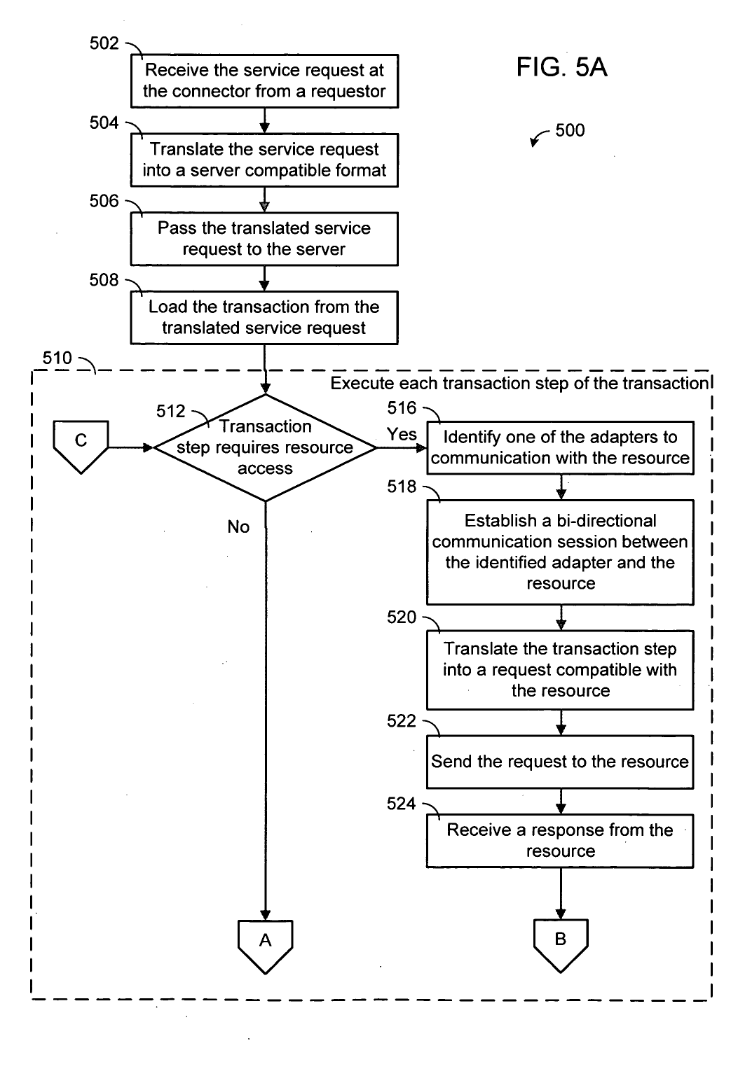

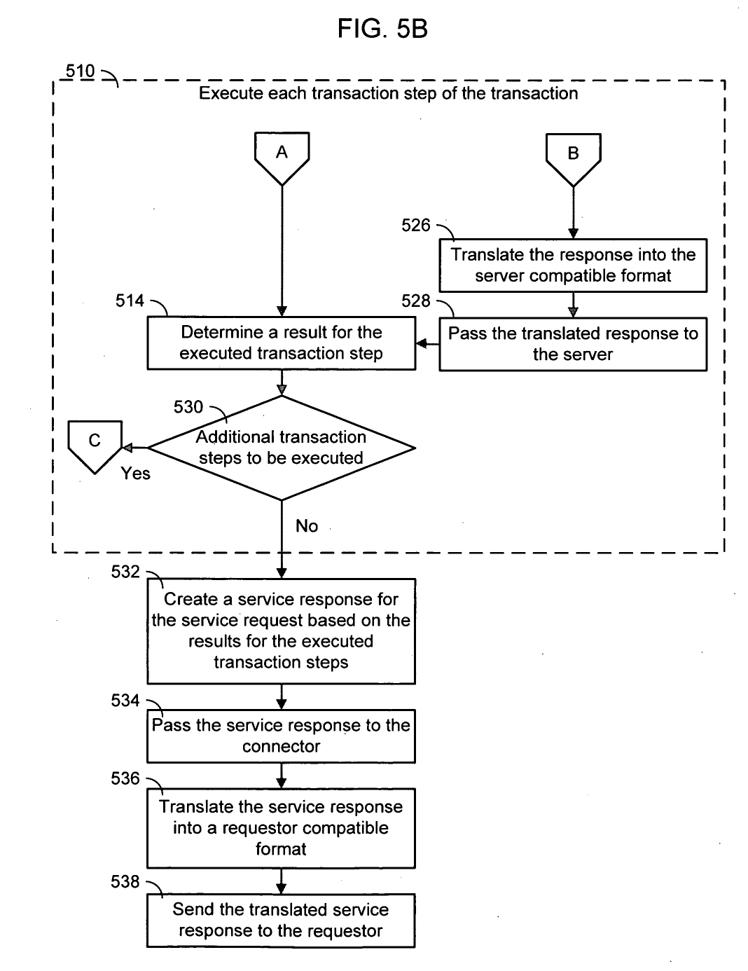

Now referring to FIGS. 5A and 5B, a method 500 for processing a transaction in accordance with the present invention is illustrated. Note that the service request is processed in real time using an enterprise integration platform that includes a server 102 communicably coupled to one or more connectors 202 and one or more adapters 204. The server 102 can be an application server, a web application server or a servlet engine that is decoupled from the requestor compatible formats. The service request is received at the connector 202 from a requestor 106 communicably coupled to the connector 202 in block 502. The service request contains a transaction comprising one or more transaction steps. The transaction links one or more systems, transforms data, exchanges data or executes workflow processes. The service request is translated into a server compatible format (e.g., a Java protocol, an Extensible Markup Language (XML) protocol, a XML Transformations (XSLT) protocol or a XML Path Language (XPath) protocol, etc.) in block 504 and the translated service request is passed to the server 102 in block 506. The translation of the service request into the server compatible format dynamically generates one or more system queries and commands. As a result, the requestor 106 views the server 102 as using the requester compatible format. The transaction is then loaded from the translated service request in block 508 and each step of the transaction is executed in block 510.

Whenever the execution of the transaction step does not require accessing a resource 120, as determined by decision block 512, a result for the executed transaction step is determined in block 514. If, however, the execution of the transaction step requires accessing a resource 120, as determined by decision block 512, one of the adapters 204 is identified to communicate with the resource 120 in block 516, a bi-directional communication session is established between the identified adapter 204 and the resource 120 in block 518, the transaction step is translated into a request compatible with the resource 120 in block 520, the request is sent to the resource 120 in block 522, a response is received from the resource 120 in block 524, the response is translated into the server compatible format in block 526 and the translated response is passed to the server 102 in block 528. A result for the executed transaction step is then determined in block 514. If additional transaction steps are to be executed, as determined in decision block 530, the process loops back to decision block 512 where the process repeats as previously described. If, however, no additional transaction steps are to be executed, as determined in decision block 530, a service response for the service request is then created based on the results for the executed transaction steps in block 532, the service response is passed to the connector 202 in block 534 where the service response is translated into a requestor compatible format in block 536 and the translated service response is sent to the requestor 106 in block 538. Note that this method can be implemented using a computer program embodied on a computer readable medium where each step is executed by one or more code segments.

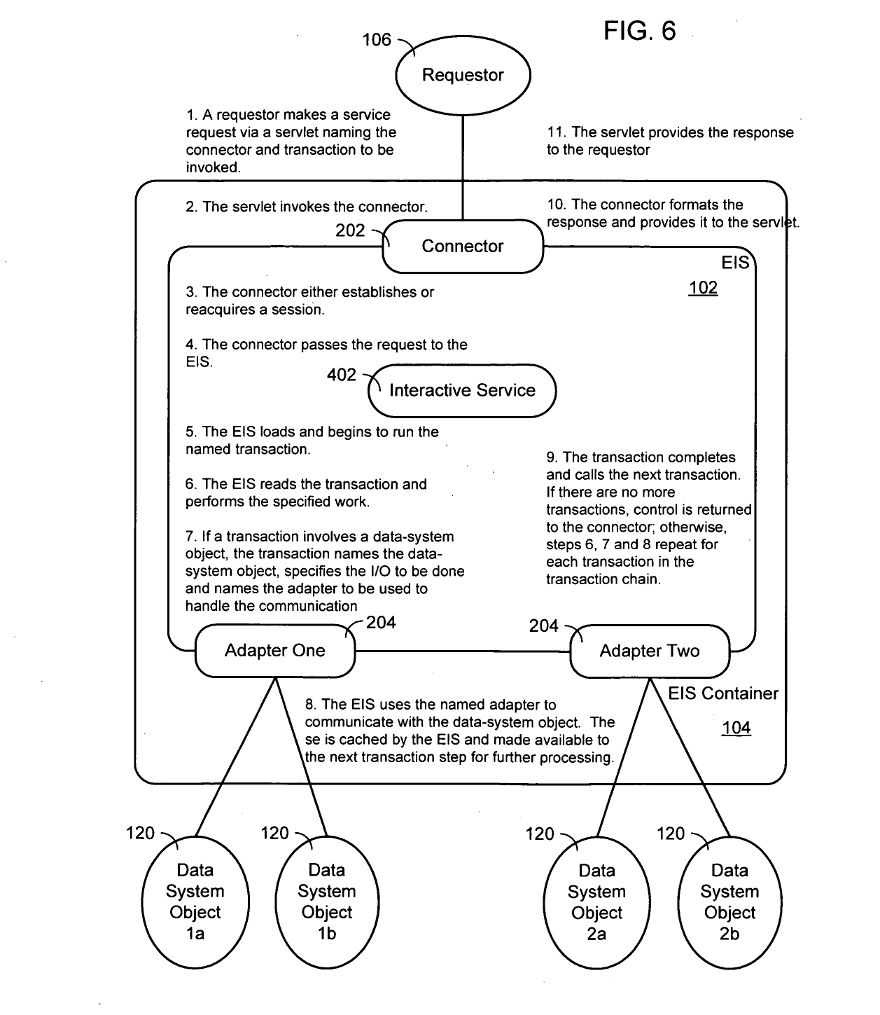

Referring now to FIG. 6, the steps involved in a request cycle and how the process is supported in accordance with one embodiment of the present invention are shown. The EIS 102 includes an interactive service 402 that is a request-response mechanism that generally provides and manages the transaction processing capabilities of the server 102. The steps are as follows:
1. A service request is initiated. The requestor 106 makes a service request via a servlet naming the connector 202 and transaction to be invoked.
2. The servlet invokes the connector 202.
3. The connector 202 either establishes or reacquires a session.
4. The connector 202 translates the inbound information and passes the service request to the server 102.
5. The server 102 loads and begins to run the transaction named in the service request.
6. The server 102 reads the transaction and performs the specified work. The transaction comprises one or more transaction steps and each transaction step is executed by the server 102.
7. If the transaction involves a data-system object (resource 120), the transaction specifies the address (URL) of the resources 120 to be accessed, the parameters (I/O to be done) to be passed to the resource 120, and the adapter 204 to be used to talk to the resource 120.
8. The adapter 204 starts and manages the bi-directional communication with the resource 120, any response from the resource 120 is received by the adapter 204 is formatted by the adapter 204 into a XML record format. The set is cached by the server 102 and made available to the next transaction step for further processing.
9. The transaction completes and calls the next transaction. If there are no more transactions, control is returned to the connector 202; otherwise, steps 6, 7 and 8 are repeated for each transaction in the transaction chain. The XML formatted response record can be translated using XSLT transformer into data or command format for the next transaction step (if any).
10. The connector 202 then formats (using appropriate XSLT transformer) the final response and provides it to the servlet.
11. The servlet provides the response to the requestor 106 and the process ends.
   Please note the server 102 operates within the industry standard security frameworks and corporate security policies which determine the system resources the server 102 may access and what resources may access it.

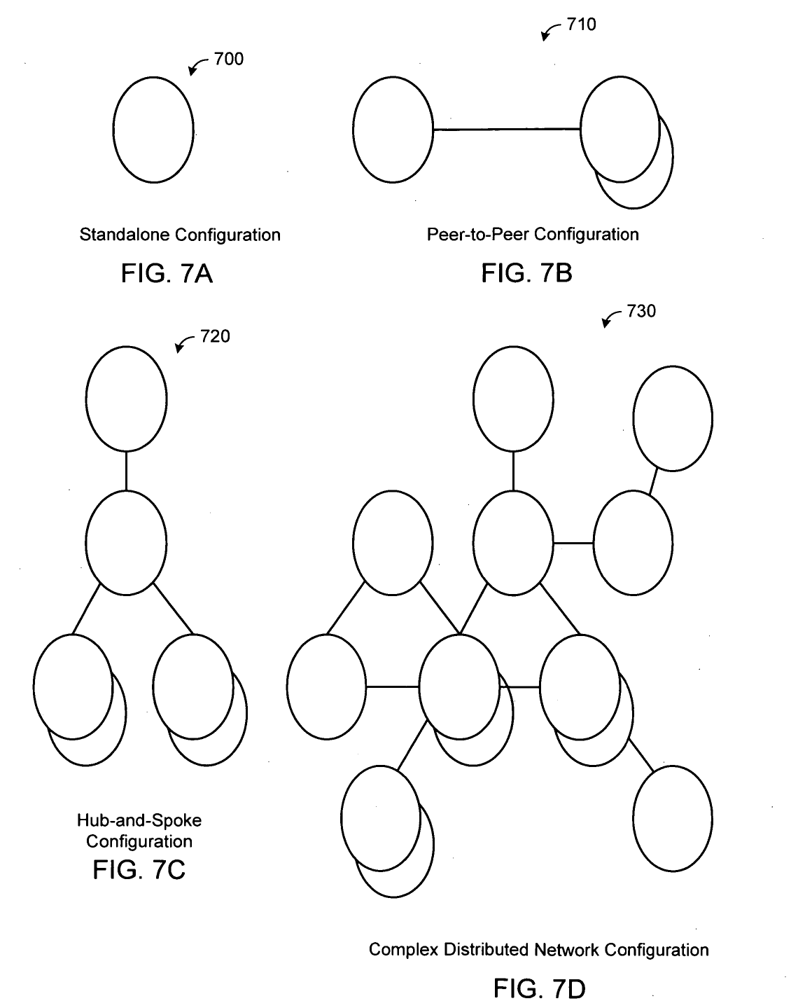

Now referring to FIGS. 7A, 7B, 7C and 7D, some of the many ways the server can be laid out in a physical network in accordance with one embodiment of the present invention are shown. The circles in this diagram are meant to denote server nodes. Each node may consist of a single server (denoted by a circle) or a cluster of servers (denoted by two overlapping circles) that share a single address on the network. Also, a server may be deployed on either a single-processor or multiple-processor computer and is designed to take full advantage of a server's multi-processor architecture.

The server is designed to operate either on its own or in association with other servers. A server can initiate requests on other servers essentially become clients of those servers. This feature provides virtually unlimited flexibility in terms of how services may be deployed in distributed networks, and provides and virtually unlimited options in terms of how servers may be deployed to meet the business and technical needs of its customers, e.g. security, network traffic considerations, scalability, high-performance, high-availability, auditability, etc. Examples of the myriad of possible server configurations include a Standalone Configuration 700 (FIG. 7A), a Peer-to-Peer Configuration 710 (FIG. 7B), a Hub-and-Spoke Configuration 720 (FIG. 7C), and a Complex Distributed Network Configuration 730 (FIG. 7D). Each logical integration server or business daemon can also be represented as a pair of primary-secondary physical components for high availability and failover purposes.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for processing a service request in real time using an enterprise integration platform comprising a server communicably coupled to one or more connectors and one or more adapters, the method comprising the steps of:
receiving the service request at the connector from a requestor communicably coupled to the connector, wherein the service request contains a transaction comprising one or more transaction steps;
translating the service request into a server compatible format;
passing the translated service request to the server;
loading the transaction from the translated service request;
executing each transaction step of the transaction by:
(a) whenever the execution of the transaction step requires accessing a resource:
(1) identifying one of the adapters to communicate with the resource;
(2) establishing a bi-directional communication session between the identified adapter and the resource;
(3) translating the transaction step into a request compatible with the resource;
(4) sending the request to the resource;
(5) receiving a response from the resource;
(6) translating the response into the server compatible format;
(7) passing the translated response to the server;
(b) determining a result for the executed transaction step;
creating a service response for the service request based on the results for the executed transaction steps;
passing the service response to the connector;
translating the service response into a requestor compatible format; and
sending the translated service response to the requestor.

2. The method as recited in claim 1, wherein the transaction links one or more systems, transforms data, exchanges data or executes workflow processes.

3. The method as recited in claim 1, wherein the server comprises an application server, a web application server or a servlet engine.

4. The method as recited in claim 1, wherein the step of translating the service request into the server compatible format dynamically generates one or more system queries and commands.

5. The method as recited in claim 1, wherein the server compatible format comprises a Java protocol, an Extensible Markup Language (XML) protocol, a XML Transformations (XSLT) protocol or a XML Path Language (XPath) protocol.

6. The method as recited in claim 1, wherein the server is decoupled from the requestor compatible formats.

7. The method as recited in claim 1, wherein the requestor views the server as using the requestor compatible format.

8. The method as recited in claim 1, wherein the requestor comprises a business daemon (scheduler), an internal application, an internal service, an external application, an external service, a browser, a flash application, a personal data assistant, a mobile phone, an instant messaging client, a text messaging device, a package application program interface (API), a legacy API, a custom API, a third party API, a web server, a gateway, a SOAP request, a message queue, a transaction manager, a directory and identity manager, an enterprise integration server or an enterprise integration server daemon.

9. The method as recited in claim. 1, wherein the connector comprises a HTML container, a XML container, a SOAP container or an AMF container.

10. The method as recited in claim 1, wherein the adapter comprises a HTTP/HTTPS adapter, a SOAP adapter, a JDBC adapter, a JMS adapter, a C code adapter, a custom application program interface adapter, an ebXML adapter, a terminal emulation adapater, a SNMP adapter, a SMTP adapter, a LDAP adapter, an ICAL adapter, an IM adapter, a SMS adapter or an ANPA adapter.

11. The method as recited in claim 1, wherein the resource comprises a web application, a packaged application, an ERP system, a CRM system, a help desk, a legacy system, a gateway, a system monitoring tool, a database, a distributed application service, a data feed, a web service, a message queue, a transaction manager, a directory/identity management system, an e-mail system, a calendar/scheduling system, an IM network, a SMS network or an EIS.

12. The method as recited in claim 1, wherein the resource comprises a data-system object.

13. The method as recited in claim 1, further comprising the step of creating the connector for the requestor.

14. The method as recited in claim 1, further comprising the step of creating the adaptor for the resource.

15. A computer program embodied on a computer readable medium for processing a service request in real time using an enterprise integration platform comprising a server communicably coupled to one or more connectors and one or more adapters, the computer program comprising:
a code segment for receiving the service request at the connector from a requestor communicably coupled to the connector, wherein the service request contains a transaction comprising one or more transaction steps;
a code segment for translating the service request into a server compatible format;
a code segment for passing the translated service request to the server;
a code segment for loading the transaction from the translated service request;
a code segment for executing each transaction step of the transaction by:
(a) whenever the execution of the transaction step requires accessing a resource:
(1) identifying one of the adapters to communicate with the resource;
(2) establishing a bi-directional communication session between the identified adapter and the resource;
(3) translating the transaction step into a request compatible with the resource;
(4) sending the request to the resource;
(5) receiving a response from the resource;
(6) translating the response into the server compatible format;
(7) passing the translated response to the server;
(b) determining a result for the executed transaction step;
a code segment for creating a service response for the service request based on the results for the executed transaction steps;
a code segment for passing the service response to the connector;
a code segment for translating the service response into a requestor compatible format; and
a code segment for sending the translated service response to the requester.

16. An enterprise integration platform for processing a service request containing a transaction comprising one or more transaction steps in real time, the enterprise integration platform comprising:
a server that loads the transaction from a translated service request, executes each transaction step of the transaction by identifying an adapter to communicate with a resource when necessary, determining a result for the executed transaction step, creating a service response for the service request based on the results for the executed transaction steps and passing the service response to a connector;
the connector communicably coupled to the server, wherein the connector receives the service request from a requestor, translates the service request into a server compatible format, passes the translated service request to the server, translates the service response into a requestor compatible format and sends the translated service response to the requestor; and
the adapter communicably coupled to the server, wherein the adapter establishes a bi-directional communication session with the resource, translates the transaction step into a request compatible with the resource, sends the request to the resource, receives a response from the resource, translates the response into the server compatible format and passes the translated response to the server.

17. The enterprise integration platform as recited in claim 16, wherein the requester is communicably coupled to the connector and the resource is communicably coupled to the adapter.

18. The enterprise integration platform as recited in claim 16, wherein the connector comprises two or more connectors and the adapter comprises two or more adapters.

19. The enterprise integration platform as recited in claim 16, wherein the platform is deployed in a standalone configuration, a peer-to-peer configuration, a hub-and-spoke configuration or a complex distributed network configuration.

20. The enterprise integration platform as recited in claim 16, further comprising:
a connector development kit communicably coupled to the server;
an adapter development kit communicably coupled to the server;
a SOAP integration wizard communicably coupled to the server;
a database integration wizard communicably coupled to the server;
an interactive service communicably coupled to the server; or
an automated service communicably coupled to the server.
